(19) United States
(12) Patent Application Publication
(10) Pub. No.: US 2026/0220485 A1
(43) Pub. Date: Jul. 30, 2026

(54) Proxy-Based Multi-Modal Learning For Render Time Prediction

(71) Applicant: Oracle International Corporation, Redwood Shores, CA (US)

(72) Inventors: Vikas Rakesh Upadhyay, Mountain View, CA (US); Sahil Malhotra, Hampton (GB)

(73) Assignee: Oracle International Corporation, Redwood Shores, CA (US)

(21) Appl. No.: 19/425,317

(22) Filed: Dec. 18, 2025

Related U.S. Application Data
(60) Provisional application No. 63/751,642, filed on Jan. 30, 2025.

(51) Int. Cl. G06N 3/0985; G06F 18/25; G06N 3/0464; G06T 15/00

(52) U.S. Cl. CPC G06N 3/0985; G06F 18/25; G06N 3/0464; G06T 15/005; G06T 2210/36; G06T 2210/61

(57) ABSTRACT

Techniques for predicting render times are disclosed. A system accesses auxiliary rendered outputs that were generated from a coarse render pass of a 3D scene description using a set of hardware resources. The system accesses system performance metrics of the set of hardware resources associated with the coarse render pass. The system encodes visual feature representations from the auxiliary rendered outputs using a convolutional neural network. The system also encodes the system performance metrics and a set of rendering configuration parameters associated with a target rendering operation. The system generates, using a multi-modal fusion model, a fused representation of the encoded visual feature representations, the encoded system performance metrics, and the encoded first set of rendering configuration parameters, using an attention-based mechanism that weights contributions of the inputs to the model. The system predicts a render time for the target rendering operation based on the fused representation.

### BENEFIT CLAIMS; RELATED APPLICATIONS; INCORPORATION BY REFERENCE

This application claims the benefit of U.S. Provisional Patent Application 63/751,642, filed Jan. 30, 2025, that is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to predicting the time needed to render images from three-dimensional (3D) scene descriptions. In particular, the present disclosure relates to using information associated with a coarse rendering process of a 3D scene description to predict the time needed to render the 3D scene description using other rendering parameters.

### BACKGROUND

Rendering is the computational process of generating photorealistic images from three-dimensional (3D) scene descriptions. Rendering is used in various applications, such as visual effects, animation, gaming, and scientific visualization. High-fidelity rendering involves solving complex light transport equations through different methods, such as ray tracing and global illumination, leading to considerable computational costs. As scene complexity increases, rendering times can extend from hours to days per frame, requiring careful resource allocation and scheduling to meet production deadlines.

The approaches described in this section are approaches that could be pursued but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for predicting a render time in accordance with one or more embodiments;

FIG. 3 illustrates an example of a proxy-based multi-modal model for predicting render time;

FIG. 4 illustrates a machine learning (ML) engine in accordance with one or more embodiments;

FIG. 5 illustrates the operation of an ML engine in accordance with one or more embodiments; and

FIG. 6 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. RENDER TIME PREDICTION ARCHITECTURE
3. PREDICTING RENDER TIME
4. EXAMPLE EMBODIMENT
5. MACHINE LEARNING ARCHITECTURE
6. GENERATIVE MODELS
7. PRACTICAL APPLICATIONS, ADVANTAGES, AND IMPROVEMENTS
8. COMPUTER NETWORKS AND CLOUD NETWORKS
9. HARDWARE OVERVIEW
10. MISCELLANEOUS; EXTENSIONS

### 1. General Overview

One or more embodiments use information from multiple modalities to predict the time needed to complete a target rendering operation on a 3D scene description. The modalities include visual features encoded from one or more coarse render passes on the 3D scene description and performance metrics associated with performing the one or more coarse render passes. The modalities also include rendering configuration parameters for the target rendering operation. The system accesses auxiliary rendered outputs generated during a coarse render pass of a 3D scene using the provided scene description using a set of hardware resources. The system accesses system performance metrics of the set of hardware resources associated with the coarse render pass. The system encodes the auxiliary rendered outputs into visual feature representations using a convolutional neural network. The system also encodes the system performance metrics and a set of rendering configuration parameters associated with a target rendering operation. The system generates, using a multi-modal fusion model, a fused representation of the encoded visual feature representations, the encoded system performance metrics, and the encoded first set of rendering configuration parameters, using an attention-based mechanism that weights contributions of the inputs to the model. The system predicts a render time for the target rendering operation based on the fused representation.

One or more embodiments described in this Specification and/or recited in the claims may not be included in this General Overview section.

### 2. Render Time Prediction Architecture

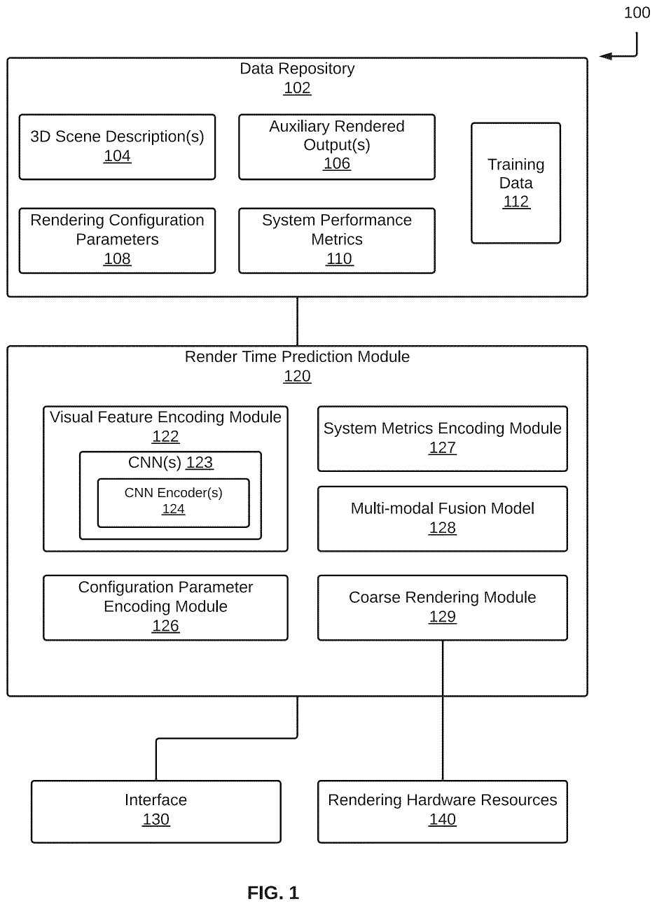

FIG. 1 illustrates a system 100 in accordance with one or more embodiments. As illustrated in FIG. 1, system 100 includes a data repository 102, a render time prediction module 120, an interface 130, and rendering hardware resources 140. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

In one or more embodiments, a data repository 102 is any type of storage unit and/or device (e.g., a file system, database, collection of tables, or any other storage mechanism) for storing data. Furthermore, a data repository 102 may include multiple different storage units and/or devices. The multiple different storage units and/or devices may or may not be of the same type or located at the same physical site. Furthermore, a data repository 102 may be implemented or executed on the same computing system as render time prediction module 120. Additionally, or alternatively, a data repository 102 may be implemented or executed on a computing system separate from render time prediction module 120. The data repository 102 may be communicatively coupled to render time prediction module 120 via a direct connection or via a network. Furthermore, data sets illustrated within the data repository 102 may be implemented across any of components within the system 100 in a decentralized and/or distributed manner. The data sets are illustrated within the data repository 102 for purposes of clarity and explanation.

In one or more embodiments, the data repository 102 stores 3D scene descriptions 104. A 3D scene description 104 may be a structured collection of data that defines what appears in a rendered image and how the rendered image should appear. A 3D scene description may include geometry information, such as the shape and structure of objects in the scene. Geometry information can include mesh data, such as vertices, edges, faces, and normals. Geometry information can include primitives, such as spheres, cubes, planes, and surfaces. Geometry information can include topology describing how vertices are connected.

A 3D scene description 104 may include lighting information that defines the sources of illumination in the scene. Lighting information can include light types, such as point, directional, spot, area, and environment lights. Lighting information can include light parameters, such as intensity, color, falloff, position, and direction. Lighting information can include shadow settings, such as hard or soft shadows, ray-traced shadows, or mapped shadows.

A 3D scene description 104 may include materials information for controlling how surfaces in the image interact with light. Materials information can include color and texture as well as values for specular, metallic, and rough textures. Materials information can include subsurface scattering, transparency, and emission characteristics of a surface.

A 3D scene description 104 may include camera information that specifies how the scene is projected to a two-dimensional (2D) image. The camera information may include the types of cameras, such as perspective, orthographic, and panoramic. The camera information may include camera parameters, such as field of view, focal length, aperture, depth of field, focus distance, and aspect ratio. The camera information may include position and orientation information of cameras in the scene.

The data repository 102 may store auxiliary rendered outputs 106. Auxiliary rendered outputs 106 may be outputs of a coarse rendering process including, or in addition to, the rendered image. Auxiliary rendered outputs 106 can include, for example, arbitrary output variables (AOVs), low-resolution renders, partial sampling renders, simplified geometry passes, preview renders, and/or analytical passes.

AOVs are custom channels of data, separate from the rendered image, that can be rendered simultaneously to provide extra information for compositing or analysis. AOVs can include specific data calculated during rendering, such as depth, object IDs, individual light contributions, or custom shader outputs, such as ambient occlusion or textures. AOVs are often output to separate layers or files from the rendered image. Types of AOVs include single-channel AOVs, three channel AOVs, and four channel AOVs. Single channel AOVs are a single value vector that stores one value per pixel in an image. The single value can represent single-value information, such as a distance from a camera, an amount of occlusion, or a grayscale mask. Three channel AOVs are a three-value vector that stores three values per pixel. The three-value vector can represent three-value information, such as a 3D coordinate, a red-green-blue (RGB) color component, surface normal, or specular/diffuse lighting components. Four channel AOVs are four-value vectors that store RGB information per pixel with an additional value for transparency. Other examples of AOVs include albedo, diffuse, diffuse-direct, diffuse-indirect, direct, indirect, ray count, shadow-matte, specular, and transmission values. In an embodiment, more than 50 different AOVs are used.

Low-resolution renders and preview renders refer to coarse render operations that produce a low-resolution or low-quality output image. These renders allow a user to verify lighting, camera angles, and other rendering parameters as well as make corrections before committing to a full render.

A partial sampling render refers to a coarse render operation that reduces the complexity of the render by, for example, lowering the resolution, using fewer light samples, using basic textures, or using simpler algorithms.

A simplified geometry pass refers to a coarse render operation that focuses on rendering visible objects in the scene with minimal calculations without performing final lighting rendering. Pixel data, such as diffuse color, surface normal, and material properties, is saved to a buffer to be used in later lighting and shading calculations.

An analytical pass refers to a coarse render operation that focuses on a particular aspect of a rendered image. For example, an analytical pass may generate an image that represents the distance of objects from a camera. An analytical pass may generate data corresponding to the directional data of surface orientations in the image. An analytical pass may generate data corresponding to the coordinates of the visible pixels in the image.

The data repository 102 may store rendering configuration parameters 108. Rendering configuration parameters 108 control how a 3D scene description is rendered into a 2D image or animation. Rendering configuration parameters 108 may include parameters that define render quality, lighting and shading, and camera(s). Render quality parameters control image quality. Render quality parameters can include a resolution and a number of samples per pixel, specifying a number of rays or samples used per pixel to compute color. Other render quality parameters can affect the smoothness of edges in the image and a bounce limit defining the number of times that a ray can reflect, refract, or transmit before being terminated.

Lighting and shading parameters define how light interacts with surfaces and materials of objects in the scene. Lighting and shading parameters can include enabling indirect light bounces, a number of times light can bounce from diffuse surfaces, resolution and softness of shadows, and how lights are sampled. Camera parameters define the framing, perspective, and exposure of the rendered image. Camera parameters can include camera position and orientation, field of view, focal length, and depth of field.

The data repository 102 may store system performance metrics 110. System performance metrics 110 includes real-time hardware resource usage metrics (e.g., CPU/GPU load, memory consumption) captured during the coarse rendering process performed by hardware resources 140. Hardware resources 140 include hardware computing components used to render images from 3D scene descriptions. Hardware resources 140 may include central processing units (CPUs), graphics processing units (GPUs), and memory. System performance metrics 110 may include hardware resource usage metrics derived or calculated after the coarse rendering process such as percentage utilization.

The data repository 102 may store training data 112. Training data 112 may include data used to train the various modules used to predict a render time as will be discussed below. Training data 112 may include, for a given 3D training scene description, the following: a plurality of sets of rendering configuration parameters, a set of fine pass rendering times, and auxiliary rendered outputs extracted from the 3D training scene description by performing one or more coarse render passes on the 3D training scene description using a training set of hardware resources. A particular fine pass rendering time corresponds to a fine pass rendering of the 3D training scene description using a particular set of training render configuration parameters of the plurality of sets of training configuration parameters.

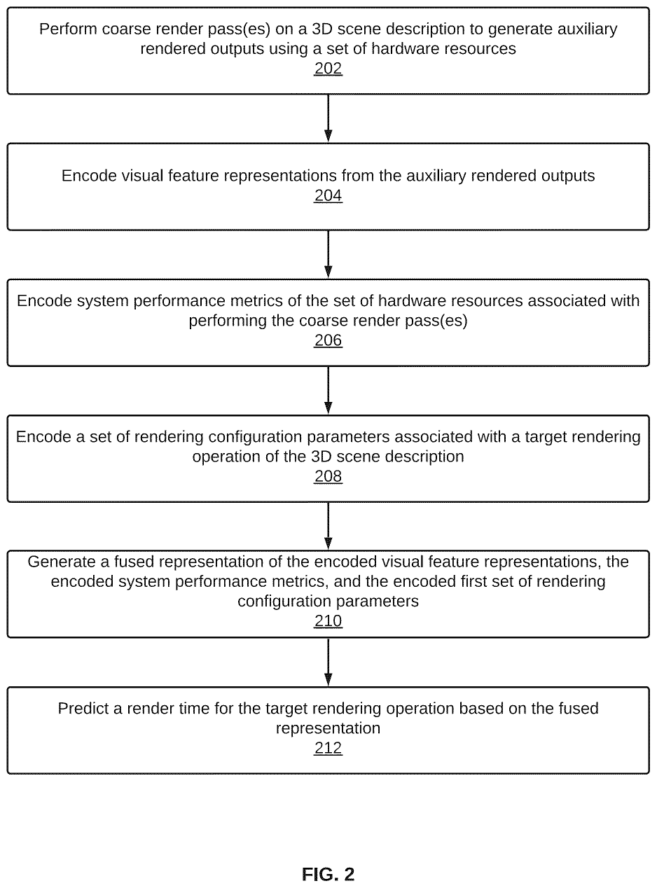

In one or more embodiments, render time prediction module 120 refers to hardware and/or software configured to perform operations described herein for predicting a render time. Examples of operations for predicting a render time are described below with reference to FIG. 2. Render time prediction module 120 may include one or more functional components, such as a visual feature encoding module 122, a configuration parameter encoding module 126, a system metrics encoding module 127, a multi-modal fusion model 128, and a coarse rendering module 129. Render time prediction module 120 may include more, fewer, or other functional components.

Visual feature encoding module 122 may include a convolutional neural network 123 (CNN 123). A CNN is a type of deep learning algorithm designed to recognize patterns in grid-like data by using specialized layers, called convolutional and pooling layers. CNNs apply filters to the input data to extract features and then reduce the complexity through pooling. CNN 123 may include one or more branches, where a branch is also a CNN that processes one visual feature configuration, e.g., one branch processes a single channel AOV, another branch processes a 3-channel AOV, and a third branch processes a 4-channel AOV.

CNN 123 may include a CNN encoder 124. CNN 123 may include one CNN encoder per branch. CNN encoder 124 includes one or more convolution layers. In a convolution layer, the CNN encoder 124 applies a filter to the grid data to detect features that match the filter's pattern. CNN encoder 124 then transforms the detected patterns into feature maps that highlight where the detected features are located in the grid data. CNN encoder 124 passes the values in the feature maps individually through a nonlinear activation function (e.g., a Rectified Linear Unit or ReLU). CNN encoder 124 may include one or more pooling layers that reduce the dimensionality of the feature maps. The output of a pooling layer may be the input to another convolution layer. Once the grid data has been processed through the convolutional layers and pooling layers, the resulting feature maps may be flattened into a one-dimensional vector that encodes latent scene complexity from the coarse render passes.

Configuration parameter encoding module 126 processes a set of rendering configuration parameters 108 through a fully connected neural network, commonly referred to as a Multi-Layer Perceptron (MLP). The MLP includes an input layer that receives raw data, one or more hidden layers, and an output layer. The MLP handles numerical inputs corresponding to the configuration parameters for a target rendering operation to produce a latent vector that integrates user-defined parameters into a prediction model. The input may be, for example, a vector having values corresponding to the set of configuration parameters.

System metrics encoding module 127 processes the system performance metrics through another fully connected neural network, e.g., an MLP. The MLP handles numerical inputs corresponding to the system performance metrics 110. This encoding captures the impact of real-time hardware utilization on render times. The output layer produces the encoded system performance metrics.

Multi-modal fusion model 128 is an attention-based fusion mechanism. Attention-based fusion is a deep learning technique that uses an attention mechanism to intelligently combine and weight information from multiple sources or modalities. Instead of relying on a simple merge, like concatenation, an attention-based fusion process dynamically assigns importance to different input features based on their relevance to a given task. Multi-modal fusion model 128 processes three input modalities (proxy visual features, system metrics, and query configurations) and combines the processed input modalities through attention-based fusion to generate render time predictions. In particular, multi-modal fusion model 128 processes the outputs of CNN 123, configuration parameter encoding module 126, and system metrics encoding module 127 through a multi-head attention model to predict a render time for a target rendering operation on a 3D scene description. Multi-modal fusion model 128 may weight the individual modalities separately according to the importance of the modality for an input. Multi-modal fusion model 128 fuses the three weighted modalities and applies a regression head to the fused representation to predict a render time. The regression head may be a fully connected network that outputs the predicted render time as a scalar value.

Coarse rendering module 129 generates a rendered image from a 3D scene description. Coarse rendering module 129 also generates the auxiliary rendered outputs 106 during a coarse rendering operation. Coarse rendering module 129 may be a rendering application capable of rendering 3D scene descriptions at a variety of rendering settings, resolutions, and complexities. Coarse rendering module 129 may be a stand-alone application, or a component of a prediction application, that performs coarse rendering and generates auxiliary rendered outputs 106 without being capable of performing high-resolution or high-complexity rendering.

In an embodiment, render time prediction module 120 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, interface 130 refers to hardware and/or software configured to facilitate communications between a user and render time prediction module 120. Interface 130 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 130 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interface 130 is specified in one or more other languages, such as Java, C, or C++.

### 3. Predicting Render Time

FIG. 2 illustrates an example set of operations for predicting a render time in accordance with one or more embodiments. One or more operations illustrated in FIG. 2 may be modified, rearranged, or omitted. Accordingly, the particular sequence of operations illustrated in FIG. 2 should not be construed as limiting the scope of one or more embodiments.

In an embodiment, the system performs one or more coarse render passes on a 3D scene description (Operation 202). The system performs the coarse render passes using a set of hardware resources, e.g., CPUs, GPUs, and memory. Coarse render passes typically capture basic geometry silhouettes, key lighting, material properties, or approximate shading details. The system generates a 2D image according to a set of coarse rendering configuration parameters applied to the 3D scene description. The set of coarse rendering configuration parameters may specify, for example, one or more of the following: a low resolution, a low number of samples per pixel, a low number of colors per pixel, a low smoothness value, or a low number of reflections for light rays. The set of coarse rendering configuration parameters may be defined such that the rendered image is produced at approximately 2% to 6% of a full render time cost. The system generates auxiliary rendered outputs during the coarse render passes. The system may generate the auxiliary rendered outputs in addition to, or instead of, the 2D image. In some cases, the 2D image may be the auxiliary rendered outputs.

The system also captures system performance metrics associated with performing the coarse render passes. The system may log various metrics, such as GPU and CPU loads, as well as memory consumption, network bandwidth usage, and disk I/O usage while performing the coarse render passes. For example, the system may use operating system monitoring tasks, performance counters, and other logging or telemetry tools to capture the system performance metrics. The system may derive or calculate system metrics after performing the coarse render passes from metrics logged during the coarse render passes. The captured system performance metrics may include metrics such as utilization rates, throughput, and latency, which can be used to understand the impact of hardware resources on render time.

In an embodiment, the system encodes visual feature representations from the auxiliary rendered outputs (Operation 204). The system derives the visual feature representations from the coarse render passes. The auxiliary rendered outputs encode geometry, lighting, and material complexity of the 3D scene description. The system may input the auxiliary rendered outputs to one or more branches of a visual feature encoding module to produce an extracted latent representation of the visual features. When multiple types of auxiliary rendered outputs are generated, the system may input the different types into different respective branches of the visual feature encoding module. For example, the system may use three branches for, respectively, a single-channel AOV, a three-channel AOV, and a four-channel AOV. When multiple branches are used, the system may concatenate the extracted latent representations into a single output vector.

In an embodiment, the system encodes system performance metrics associated with performing the coarse render passes (Operation 206). The system inputs the system performance metrics to a fully connected neural network, e.g., a system metrics encoding module. The system provides numerical values corresponding to the system performance metrics to an input layer of the neural network. The neural network processes the system performance metrics in one or more hidden layers. The nodes in the hidden layers take in multiple inputs, apply a weighted sum to an input, add a bias, and pass the result through a nonlinear activation function. The output of one node may be provided to another node in another hidden layer. The output of the neural network encodes the effect of the hardware utilization on the render time.

In an embodiment, the system encodes a set of rendering configuration parameters associated with a target rendering operation of the 3D scene description (Operation 208). The system inputs the rendering configuration parameters to a fully connected neural network, e.g., a configuration parameter encoding module. The system provides numerical inputs, corresponding to the configuration parameters for a target rendering operation, to an input layer of the neural network. The neural network processes the rendering configuration parameters in one or more hidden layers. The nodes in the hidden layers take in multiple inputs, apply a weighted sum to an input, add a bias, and pass the result through a nonlinear activation function. The output of one node may be provided to another node in another hidden layer. The output of the neural network is a latent vector that integrates user-defined parameters into a prediction model input.

In an embodiment, Operations 204, 206, and 208 can be performed sequentially in any order. In an embodiment, two or more of Operations 204, 206, and 208 can be performed in parallel.

In an embodiment, the system generates a fused representation of the encoded visual feature representations, the encoded system performance metrics, and the encoded set of rendering configuration parameters (Operation 210). The encoded visual feature representations, the encoded system performance metrics, and the encoded set of rendering configuration parameters may be input vectors for a multimodal fusion model. For a given input vector, the system may generate additional vectors: a query vector, a key vector, and a value vector. The query vector represents what the model is looking for. The key vector represents the information that the input vector contains. The value vector holds the values of the input vector.

The system may calculate attention weights for the query, key, and value vectors. The system may compute a score by measuring the similarity between the query of one of the input vectors and the key vectors of the other input vectors. The system converts the raw scores into a probability distribution using a softmax function, resulting in the attention weights. The system uses the attention weights to calculate a weighted sum of the value vectors of the input vectors, resulting in a context vector that summarizes the relevant information from the input vectors.

In an embodiment, the system predicts a render time for the target rendering operation based on the fused representation (Operation 212). The system uses the context vector from the multimodal fusion model as input to a regression head to predict the render time. The regression head may be a final standard regression layer in the multimodal fusion model. The regression head may be a stand-alone fully connected neural network trained to output a scalar render time from a fused representation of the context vector.

In an embodiment, the system uses the predicted render time in a scheduling operation for the target rendering operation. The system may provide the predicted render time as an input to a scheduling application. The system may identify a set of hardware resources that will be available for a time period at least equal to the predicted render time and reserve the set of hardware resources for the target rendering operation.

In an embodiment, the system allows a user to query the model multiple times with different rendering configuration parameters to obtain estimates of render time for various scenarios. The user can input different configuration parameters, such as resolution, sample rate, or lighting effects, and the model will generate a new estimate of render time based on the updated parameters. This enables the user to explore different rendering options and make informed decisions about the optimal configuration for their specific use case.

### 4. Example Embodiment

A detailed example is described below for purposes of clarity. Components and/or operations described below should be understood as one specific example that may not be applicable to certain embodiments. Accordingly, components and/or operations described below should not be construed as limiting the scope of any of the claims.

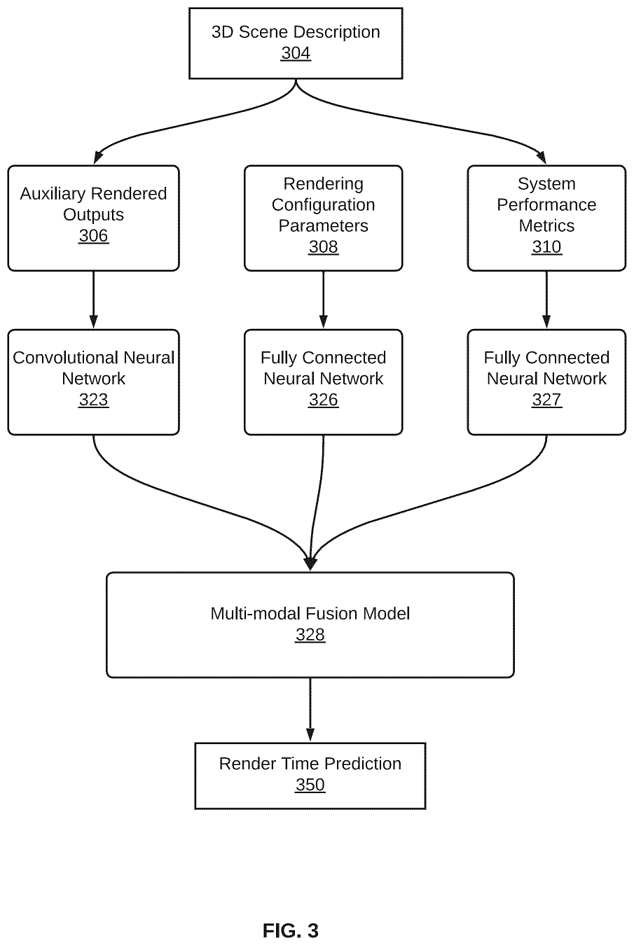

FIG. 3 illustrates a visual representation of a proxy-based multi-modal model for predicting render time that may be used by a movie studio to predict the time needed to render a scene that includes a spaceship that is moving past a planet. The spaceship may have many flat surfaces positioned at various angles to one another or ovoid and rounded. The surfaces may be metallic or otherwise reflective. The planet may have atmospheric features such as clouds, and surface features such as oceans, mountains, and city lights.

The 3D scene description 304 can include a spaceship model that may include thousands of individually shaded parts, such as hull plating, cockpit glass, emissive engine cores, and antennas. The 3D scene description 304 can include the planet as a sphere with high-resolution displacement maps, multiple texture layers (e.g., color, roughness, specular, cloud opacity), and atmosphere shaders including Rayleigh/Mie scattering. The 3D scene description 304 can include lights, such as a distant sun, bounce lights, rim lights for shaping the ship, and possibly volumetric light if the ship passes through dust or nebulae. The 3D scene description 304 can include virtual camera that mirror real cinematography, that is, describes by lens focal length, film back size, shutter angle, and camera movement (e.g., a slow dolly or pan following the spacecraft).

Auxiliary rendered outputs 306 represent visual features of the 3D scene description 304 and serve as a proxy for the complexities that exist in the 3D scene description 304. The system generates the auxiliary rendered outputs 306 during one or more coarse render passes of 3D scene description 304. The system also records or determines system performance metrics 310 of the hardware resources used to perform the one or more coarse render passes.

A user at the movie studio may specify rendering configuration parameters 308 associated with a target rendering operation. The rendering configuration parameters 308 and the target rendering operation may be specified to produce a fully rendered image. The rendering configuration parameters 308 may include dozens or hundreds of fine-tuning parameters. Some examples include: lighting and sampling parameters, shading and geometry parameters; camera and motion parameters; and optimization controls.

Lighting and sampling parameters can specify the number of pixel samples to use in rendering, i.e., the total rays per pixel. A higher number means less noise but longer render times. Lighting and sampling parameters can specify per-channel sampling weights for diffuse samples, glossy samples, and specular samples. Lighting and sampling parameters can specify a maximum ray depth, i.e., a maximum number of bounces allowed for a light ray for various lighting characteristics such as reflection depth, refraction depth, and diffuse depth. Lighting and sampling parameters can specify a light cutoff threshold that terminates negligible light paths early in the rendering process. Lighting and sampling parameters can specify a volume step size for a distance between volume scattering computations for the planet atmosphere, and any nebula.

Shading and geometry parameters can specify a displacement tessellation rate that controls geometric detail on the planet's surface. Shading and geometry parameters can specify texture filtering and mipmap level clamp to limit the sharpness of textures in distant shots. Shading and geometry parameters can specify subdivision levels to control smoothing on the ship's hull or curved features.

Camera and motion parameters can specify shutter speed and/or shutter curve that determines the motion blur curve for the moving ship. Camera and motion parameters can specify depth of field settings such as F-stop and focus distance. Camera and motion parameters can specify camera overscan for extra pixels around the edges for stabilizing the shot in post.

Optimization controls can specify an adaptive sampling threshold to stop sampling early in clean areas. Optimization controls can specify a bucket size and/or tile size that affects memory usage and parallelism. Optimization controls can specify a cryptomatte setup that specifies objects and materials to be ID tagged for a later compositing process.

Convolutional neural network 323 includes one or more branches to receive the auxiliary rendered outputs 306 as inputs. Convolutional neural network 323 may include one convolutional branch per input configuration, for example, one branch for single-channel AOVs, one branch for three-channel AOVs, and one branch for four-channel AOVs. A given convolutional branch may include one or more hidden convolutional layers in addition to an input layer and an output layer. Alternatively, the convolutional neural network 323 may have one convolutional branch that receives the entirety of the auxiliary rendered outputs 306. Convolutional neural network 323 produces a multidimensional vector that reflects the visual features that effect render times.

The AOVs can include, for example, a beauty pass, diffuse direct, diffuse indirect, specular direct, specular indirect, emission, and transmission. A beauty pass is a fully shaded image that provides verification of shot composition, camera, lighting, and overall look, while being very noisy. Diffuse Direct demonstrates direct lighting placement and the interaction of key lights with the ship and planet and appears as noisy direct light patches. Diffuse indirect (or global illumination) checks the bounce light color and intensity, for example, the soft light from the planet that might be illuminating the spaceship, and appears as splotchy gradients at low sample numbers. Specular direct can highlight behavior on the spaceship's metal hull and atmospheric glints on the planet and appears as sparkly noise in highlight regions. Specular indirect shows reflections and allows confirmation that, for example, the planet is correctly reflected on the ship. Emission validates glowing elements such as engine output or city lights. Transmission checks scattering behavior, for example, in clouds or atmospheric layers.

Fully connected neural network 326 receives the rendering configuration parameters 308 as inputs. Fully connected neural network 326 encodes the rendering configuration parameters 308 through one or more hidden layers to produce a vector that represents the rendering configuration parameters 308 for use in the prediction.

Fully connected neural network 327 receives system performance metrics 310 as inputs. Fully connected neural network 327 encodes the system performance metrics 310 to produce a vector of values that reflect the effect of the hardware utilization on render times.

Multi-modal fusion model 328 weights the individual output vectors of the convolutional neural network 323, fully connected neural network 326, and fully connected neural network 327 in accordance with a relevance of an output vector's values to the inputs. The multi-modal fusion model 328 fuses the weighted output vectors with a multiheaded attention mechanism to generate a fused representation.

The multi-modal fusion model 328 produces a render time prediction 350 with a regression head based on the fused representation. Render time prediction 350 is a scalar time value that reflects the expected time that the target render operation on the 3D scene description 304 will take to complete given the rendering configuration parameters 308. The render time prediction 350 may be in units of time, such as in seconds, minutes, hours, or days. The render time prediction 350 may be in terms of hardware cycles, such as GPU or CPU cycles.

The render time prediction 350 is more accurate than conventional methods of predicting render times due to the encoding of the visual features of the 3D scene description into the auxiliary rendered outputs, combined with consideration of the hardware performance during the coarse render passes and the parameters of the target rendering operation.

The multi-modal fusion model 328 may be applied repeatedly to the auxiliary rendered outputs 306 using different rendering configuration parameters 308, without having to repeat the coarse render passes, to identify a particular set of rendering configuration parameters 308 that provide an acceptable balance between rendering time and image quality. For example, if the initial prediction time exceeds a desired amount, the movie studio user could reduce the pixel sample number, ray depth, secondary ray sampling, and/or volume step size in the rendering configuration parameters 308, re-encode the rendering configuration parameters 308, and re-apply the multi-modal fusion model 328. Similarly, if the predicted render time is lower than expected, the user can increase the one or more of the rendering configuration parameters 308 so that the target rendering operation would produce a finer quality render and reapply the multi-modal fusion model 328.

In an embodiment, the system may apply the multi-modal fusion model 328, using multiple sets of rendering configuration parameters 308, to generate multiple render time predictions 350. The system may recommend a particular set of rendering configuration parameters 308 based on one or more criteria associated with a render time prediction 350. For example, the system may recommend the particular set of rendering configuration parameters associated with the shortest render time prediction. The system may present a selection of a first set of rendering configuration parameters in association with a first render time prediction and a second set of rendering configuration parameters in association with a second render time prediction for user selection. The system may perform the target rendering operation using the particular set of rendering configuration parameters selected by the user.

The predicted render time can be used to inform decisions about resource allocation and job scheduling. For instance, if the predicted render time is 30 minutes, the system may recommend allocating a specific set of hardware resources (e.g., GPU, CPU, memory) to complete the rendering operation within a certain time frame. The system may also suggest scheduling the rendering operation during a specific time period when the hardware resources are available.

### 5. Machine Learning Architecture

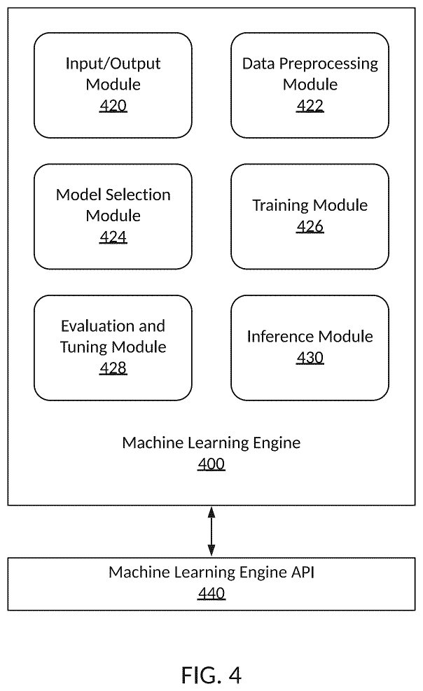

FIG. 4 illustrates a machine learning engine 400 in accordance with one or more embodiments. As illustrated in FIG. 4, machine learning engine 400 includes input/output module 420, data preprocessing module 422, model selection module 424, training module 426, evaluation and tuning module 428, and inference module 430.

In accordance with an embodiment, input/output module 420 serves as the primary interface for data entering and exiting the system, managing the flow and integrity of data. This module may accommodate a wide range of data sources and formats to facilitate integration and communication within the machine learning architecture.

In an embodiment, an input handler within input/output module 420 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 420 to be versatile in different operational contexts, whether processing historical datasets or streaming data.

In accordance with an embodiment, input/output module 420 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 420 includes an output framework designed to handle the distribution and exportation of outputs, predictions, or insights. Using the output framework, input/output module 420 formats these outputs into user-friendly and accessible formats, such as reports, visualizations, or data files compatible with other systems. Input/output module 420 also ensures secure and efficient transmission of these outputs to end-users or other systems in an embodiment and may employ encryption and secure data transfer protocols to maintain data confidentiality.

In accordance with an embodiment, data preprocessing module 422 transforms data into a format suitable for use by other modules in machine learning engine 400. For example, data preprocessing module 422 may transform raw data into a normalized or standardized format suitable for training ML models and for processing new data inputs for inference. In an embodiment, data preprocessing module 422 acts as a bridge between the raw data sources and the analytical capabilities of machine learning engine 400.

In an embodiment, data preprocessing module 422 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 422 may be configured to handle anomalies in different ways depending on context. Data preprocessing module 422 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 422 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 422 processes new data for inference, data preprocessing module 422 replicates the same preprocessing steps to ensure consistency with the training data format. This helps to avoid discrepancies between the training data format and the inference data format, thereby reducing the likelihood of inaccurate or invalid model predictions.

In an embodiment, model selection module 424 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 424 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 424 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 424 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 424 also considers computational efficiency and resource constraints. This is meant to help ensure the selected model is both accurate and practical in terms of computational and time requirements. In an embodiment, certain features of model selection module 424 are configurable such as a configured bias toward (or against) computational efficiency.

In accordance with an embodiment, training module 426 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 426 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 426 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 426 includes logic to handle different types of data and learning tasks. For instance, it includes different training routines for supervised learning (where the training data comes with labels) and unsupervised learning (without labeled data). In the case of deep learning models, training module 426 also manages the complexities of training neural networks that include initializing network weights, choosing activation functions, and setting up neural network layers.

In an embodiment, evaluation and tuning module 428 incorporates dynamic feedback mechanisms and facilitates continuous model evolution to help ensure the system's relevance and accuracy as the data landscape changes. Evaluation and tuning module 428 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 428 performs continuous model tuning by using hyperparameter optimization. Evaluation and tuning module 428 performs an exploration of the hyperparameter space using algorithms, such as grid search, random search, or more sophisticated methods like Bayesian optimization. Evaluation and tuning module 428 uses these algorithms to iteratively adjust and refine the model's hyperparameters—settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation and tuning module 428 integrates data feedback and updates the model. Evaluation and tuning module 428 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 428 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 428 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 430 transforms data raw data into actionable, precise, and contextually relevant predictions. In addition to processing and applying a trained model to new data, inference module 430 may also include post-processing logic that refines the raw outputs of the model into meaningful insights.

In an embodiment, inference module 430 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 430 transforms the outputs of a trained model into definitive classifications. Inference module 430 employs the underlying model as a tool to generate probabilistic outputs for each potential class. It then engages in an interpretative process to convert these probabilities into concrete class labels.

In an embodiment, when inference module 430 receives the probabilistic outputs from the model, it analyzes these probabilities to determine how they are distributed across some or every potential class. If the highest probability is not significantly greater than the others, inference module 430 may determine that there is ambiguity or interpret this as a lack of confidence displayed by the model.

In an embodiment, inference module 430 uses thresholding techniques for applications where making a definitive decision based on the highest probability might not suffice due to the critical nature of the decision. In such cases, inference module 430 assesses if the highest probability surpasses a certain confidence threshold that is predetermined based on the specific requirements of the application. If the probabilities do not meet this threshold, inference module 430 may flag the result as uncertain or defer the decision to a human expert. Inference module 430 dynamically adjusts the decision thresholds based on the sensitivity and specificity requirements of the application, subject to calibration for balancing the trade-offs between false positives and false negatives.

In accordance with an embodiment, inference module 430 contextualizes the probability distribution against the backdrop of the specific application. This involves a comparative analysis, especially in instances where multiple classes have similar probability scores, to deduce the most plausible classification. In an embodiment, inference module 430 may incorporate additional decision-making rules or contextual information to guide this analysis, ensuring that the classification aligns with the practical and contextual nuances of the application.

In regression models, where the outputs are continuous values, inference module 430 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 430 incorporates domain-specific adjustments into its post-processing routine. This involves tailoring the model's output to align with specific industry knowledge or contextual information. For example, in financial forecasting, inference module 430 may adjust predictions based on current market trends, economic indicators, or recent significant events, ensuring that the outputs are both statistically accurate and practically relevant.

In an embodiment, inference module 430 includes logic to handle uncertainty and ambiguity in the model's predictions. In cases where inference module 430 outputs a measure of uncertainty, such as in Bayesian inference models, inference module 430 interprets these uncertainty measures by converting probabilistic distributions or confidence intervals into a format that can be easily understood and acted upon. This provides users with both a prediction and an insight into the confidence level of that prediction. In an embodiment, inference module 430 includes mechanisms for involving human oversight or integrating the instance into a feedback loop for subsequent analysis and model refinement.

In an embodiment, inference module 430 formats the final predictions for end-user consumption. Predictions are converted into visualizations, user-friendly reports, or interactive interfaces. In some systems, like recommendation engines, inference module 430 also integrates feedback mechanisms, where user responses to the predictions are used to continually refine and improve the model, creating a dynamic, self-improving system.

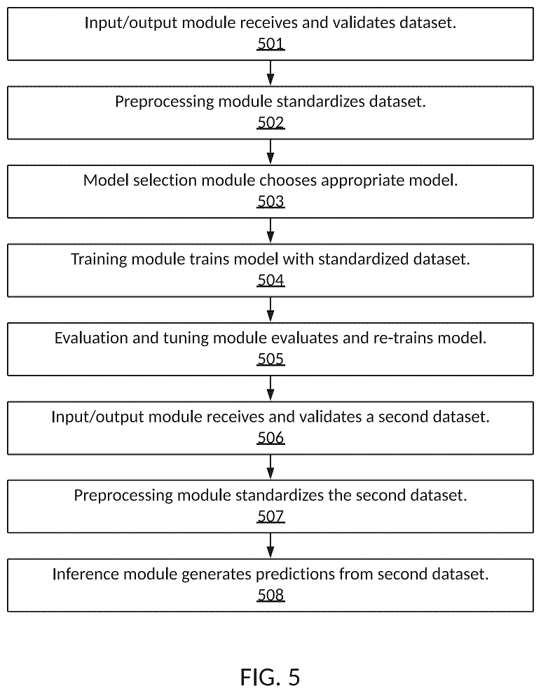

FIG. 5 illustrates the operation of a machine learning engine in one or more embodiments. In an embodiment, input/output module 420 receives a dataset intended for training (Operation 501). This data can originate from diverse sources, like databases or real-time data streams, and in varied formats, such as CSV, JSON, or XML. Input/output module 420 assesses and validates the data, ensuring its integrity by checking for consistency, data ranges, and types.

In an embodiment, training data is passed to data preprocessing module 422. Here, the data undergoes a series of transformations to standardize and clean it, making it suitable for training ML models (Operation 502). This involves normalizing numerical data, encoding categorical variables, and handling missing values through techniques like imputation.

In an embodiment, prepared data from the data preprocessing module 422 is then fed into model selection module 424 (Operation 503). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 426 trains the selected model with the prepared dataset (Operation 504). It implements learning algorithms to adjust the model's internal parameters, optimizing them to identify patterns and relationships in the training data. Training module 426 also addresses the challenge of overfitting by implementing techniques, like regularization and early stopping, ensuring the model's generalizability.

In an embodiment, evaluation and tuning module 428 evaluates the trained model's performance using the validation dataset (Operation 505). Evaluation and tuning module 428 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 420 receives a dataset intended for inference. Input/output module 420 assesses and validates the data (Operation 506).

In an embodiment, data preprocessing module 422 receives the validated dataset intended for inference (Operation 507). Data preprocessing module 422 ensures that the data format used in training is replicated for the new inference data, maintaining consistency and accuracy for the model's predictions.

In an embodiment, inference module 430 processes the new data set intended for inference, using the trained and tuned model (Operation 508). It applies the model to this data, generating raw probabilistic outputs for predictions. Inference module 430 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 440 allows for applications to leverage machine learning engine 400. In an embodiment, machine learning engine API 440 may be built on a RESTful architecture and offer stateless interactions over standard HTTP/HTTPS protocols. Machine learning engine API 440 may feature a variety of endpoints, each tailored to a specific function within machine learning engine 400. In an embodiment, endpoints such as /submitData facilitate the submission of new data for processing, while /retrieveResults is designed for fetching the outcomes of data analysis or model predictions. The MLE API may also include endpoints like /updateModel for model modifications and /trainModel to initiate training with new datasets.

In an embodiment, machine learning engine API 440 is equipped to support SOAP-based interactions. This extension involves defining a WSDL (Web Services Description Language) document that outlines the API's operations and the structure of request and response messages. In an embodiment, machine learning engine API 440 supports various data formats and communication styles. In an embodiment, machine learning engine API 440 endpoints may handle requests in JSON format or any other suitable format. For example, machine learning engine API 440 may process XML, and it may also be engineered to handle more compact and efficient data formats, such as Protocol Buffers or Avro, for use in bandwidth-limited scenarios.

In an embodiment, machine learning engine API 440 is designed to integrate WebSocket technology for applications necessitating real-time data processing and immediate feedback. This integration enables a continuous, bi-directional communication channel for a dynamic and interactive data exchange between the application and machine learning engine 400.

In an embodiment, a training data set for a 3D scene render time prediction may include one or more sets of 3D training scene descriptions, and their respective coarse renders, auxiliary render outputs, render configurations, system performance metrics and a set of fine pass rendering times. A given fine pass rendering time corresponds to a fine pass rendering of the 3D training scene description using a particular set of training render configuration parameters of the plurality of sets of training render configuration parameters. The training data set may also include auxiliary rendered outputs extracted from the 3D training scene description by performing one or more coarse render passes on the 3D training scene description using a training set of hardware resources.

The system trains the multi-modal fusion model with the training data set with a training process. The training process includes encoding visual feature representations from the auxiliary rendered outputs using one or more convolutional neural networks (CNNs) with a first set of visual feature encoders. The training process also includes encoding system performance metrics with a second encoder. The system performance metrics are associated with the set of training hardware resources and captured during the one or more coarse render passes. The training process then generates a set of encoded training render configuration parameters for each respective set of training render configuration parameters in the plurality of sets of training render configuration parameters using a third encoder.

Next, the training process includes, for each particular set of training render configuration parameters, generating a fused representation of inputs using an attention-based mechanism that weights contributions of the respective inputs using a third set of weights. The inputs include the encoded visual feature representations, the encoded system performance metrics, and the encoded particular set of training configuration parameters.

The system predicts a render time based, at least in part, on the fused representation of inputs and compares the predicted render time to the given fine pass rendering time that corresponds to the particular set of training render configuration parameters. When the predicted render time does not satisfy a learning condition with respect to the fine pass rendering time, the system modifies at least one of the first encoder, the second encoder, or the third set of weights, and then repeats the training process until the predicted render time satisfies the learning condition. The system may define the learning condition as a mean squared error loss function, which computes the difference between the predicted render time and the given fine pass render time. For true values y₁, . . . , yₙ and predictions ŷ₁, . . . , ŷₙ:

$$MSE = \frac{1}{n} {\sum }_{i = 1}^{n} {( {y}_{i} - {\hat{y}}_{i} )}^{2}$$

This loss function provides a quantitative measure of the difference between the predicted and actual render times, allowing the system to evaluate the accuracy of its predictions. The system may compute the loss by subtracting the given fine pass render time from the predicted render time, squaring the result, and averaging the squared differences over the training data. The system may then use an optimization algorithm to adjust the model's parameters to minimize the loss. The system updates the model parameters, including the visual feature encoding module, system metrics encoding module, and multi-modal fusion model, to minimize the MSE loss function. If the predicted render time does not satisfy the learning condition (e.g., the loss is above a certain threshold), the system modifies the model parameters and repeats the training process until convergence.

By minimizing the loss, the system can improve the accuracy of its render time predictions. The system may train until the difference between the squares of the predicted render time and the given fine pass render time is minimized. The system may stop training when a convergence criterion is met, such as when the loss reaches a minimum threshold or when no further improvement is observed. For example, the system may stop training when no improvement in the predicted render time has occurred after a specified number of cycles, or when an acceptable error rate has been reached.

In an embodiment, during training, the visual feature encoding module, system metrics encoding module, and multi-modal fusion model are updated to optimize the model's performance in predicting render times. The weights and biases of the convolutional neural networks in the visual feature encoding module are adjusted during training. Similarly, the weights and biases of the fully connected neural network in the system metrics encoding module are also updated. The attention weights in the multi-modal fusion model are learned during training to dynamically weigh the contributions of each modality. In contrast, the architecture of the model, including the convolutional neural networks, fully connected neural networks, and attention mechanism, may be predefined and not modified during training. The regression head, which predicts the final render time, is also trained during this process to output a scalar value that accurately represents the predicted render time.

### 6. Generative Models

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks like unsupervised learning, semi-supervised learning, and domain adaptation.

One type of generative model is a large language model. Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a softmax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 420, when used for large language models, handles textual data, converting input text into a format that the model can process. This typically involves tokenization, where the text is broken down into manageable pieces, such as words or sub words, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 422 in the context of large language models may include steps such as normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module 424, when used for large language models involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 426, when used for large language models, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware such as GPUs (Graphics Processing Units) or TPUs (Tensor Processing Units) to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 428 assesses the performance of large language models using metrics such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 430, in the context of large language models, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, CNNs are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

The self-attention mechanism, which is part of a transformer network, enables the model to weigh the importance of different elements within an input sequence, regardless of their position. This allows the model to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### 7. Practical Applications, Advantages, and Improvements

Embodiments provide several practical applications, advantages, and improvements over existing rendering time prediction methods. These advantages and improvements include a low-cost process that results in improved accuracy in rendering time prediction. Accurate render time prediction is important for optimizing resource allocation, scheduling, and cost management in large-scale production rendering pipelines.

Embodiments improve accuracy by considering dependencies among scene complexity, rendering configurations, and hardware performance in a rendering operation. The system uses coarse render passes that are low-cost representations of visual features, encoding geometric, material, and lighting complexity from a 3D scene description. The low-cost representations enable structured feature extraction for deep learning-based regression. These encoded complexities are fused with system metrics and structured rendering configurations via a multi-headed attention-based fusion mechanism, significantly enhancing predictive accuracy. Embodiments have demonstrated a 53% reduction in prediction error over conventional methods.

Embodiments improve the efficiency and scalability of rendering workflows in various industries, such as film production, gaming, and scientific visualization. Using coarse render passes reduces computational overhead. Reducing computational overhead improves sustainability in the render time prediction process, potentially lowering energy use in render farms by 10-20% by enabling better planning and scheduling. The render time prediction process improves sustainability by enabling optimized resource allocation in rendering pipelines. This directly contributes to energy efficiency in large-scale rendering environments such as cloud-based render farms. Additionally, the render time prediction process democratizes high-quality rendering technologies by lowering computational barriers for smaller studios and independent creators.

Embodiments provide a flexible and scalable prediction model that can accommodate multiple and diverse rendering configurations. The system encodes the rendering configuration parameters for a target rendering operation as a separate input in the multi-headed attention fusion model, enabling different rendering times to be predicted by merely changing the rendering configuration parameters input.

### 8. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally, or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

### 9. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

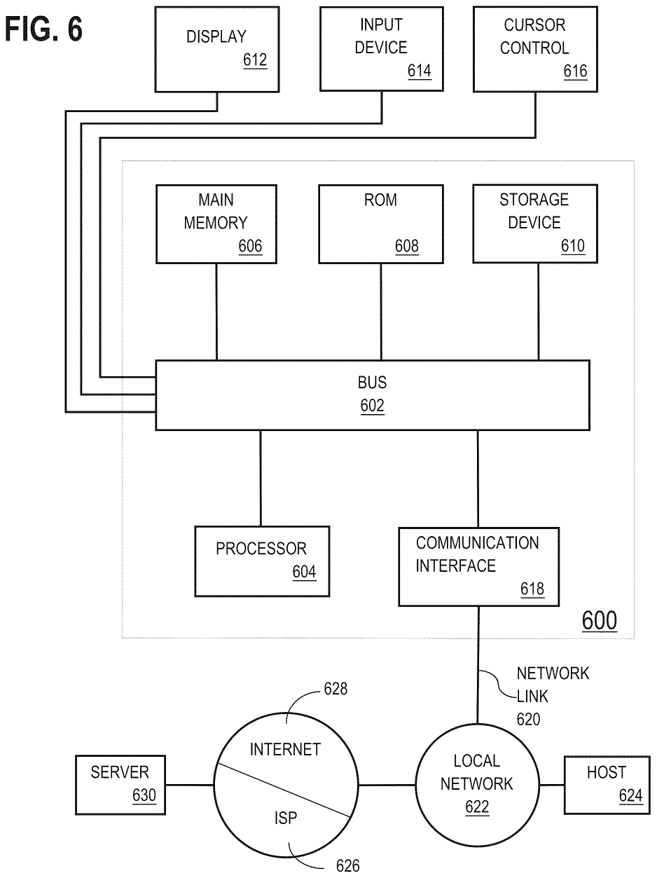

For example, FIG. 6 is a block diagram that illustrates a computer system 600 upon which an embodiment of the disclosure may be implemented. Computer system 600 includes a bus 602 or other communication mechanism for communicating information, and a hardware processor 604 coupled with bus 602 for processing information. Hardware processor 604 may be, for example, a general-purpose microprocessor.

Computer system 600 also includes a main memory 606, such as a random-access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read-only memory (ROM) 608 or other static storage device coupled to bus 602 for storing static information and instructions for processor 604. A storage device 610, such as a magnetic disk, optical disk, or a solid-state drive (SSD), is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, SSD, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or SSD of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the worldwide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 10. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, a computer program product includes instructions that, when executed by one or more hardware processors, causes performance of any of the operations described herein and/or recited in any of the claims.

In an embodiment, one or more non-transitory computer-readable storage media store instructions that, when executed by one or more hardware processors, cause performance of any of the operations described herein and/or recited in any of the claims. As used herein, the term “non-transitory computer-readable medium” refers to any tangible storage medium that stores computer-executable instructions for execution by one or more hardware processors in a computing device(s). The term “non-transitory” excludes transitory, propagating signals per se, such as carrier waves or other electromagnetic signals, but includes all forms of physical storage media.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method, comprising:
accessing auxiliary rendered outputs generated from performing one or more coarse render passes on a three-dimensional (3D) scene description using a set of hardware resources;
accessing system performance metrics of the set of hardware resources associated with the one or more coarse render passes;
encoding visual feature representations from the auxiliary rendered outputs using one or more convolutional neural networks (CNNs);
encoding the system performance metrics;
encoding a first set of rendering configuration parameters associated with a target rendering operation of the 3D scene description;
generating, using a multi-modal fusion model, a first fused representation of inputs comprising the encoded visual feature representations, the encoded system performance metrics, and the encoded first set of rendering configuration parameters, using an attention-based mechanism that weights contributions of the respective inputs; and
predicting a first render time for the target rendering operation based at least in part on the first fused representation;
wherein the method is performed by at least one device including a hardware processor.

2. The method of claim 1, further comprising:
performing the one or more coarse render passes on the 3D scene description to generate the auxiliary rendered outputs using the set of hardware resources; and
capturing one or more of the system performance metrics while performing the one or more coarse render passes.

3. The method of claim 1, wherein the auxiliary rendered outputs comprise first arbitrary output variables (AOVs).

4. The method of claim 3, wherein the first AOVs comprise one or more of single-channel AOVs, three-channel AOVs, or four-channel AOVs.

5. The method of claim 1, wherein auxiliary rendered outputs comprise outputs generated by performing at least one of: a low-resolution render, a partial sampling render, a simplified geometry pass, a preview render, or an analytical pass.

6. The method of claim 1, wherein the configuration parameters comprise one or more of:
resolution, sample rate, bounce limit, camera parameters, lighting parameters, material parameters, texture parameters, or render settings.

7. The method of claim 1, further comprising: using the first render time in a scheduling operation for the target rendering operation.

8. The method of claim 1, further comprising:
encoding a second set of rendering configuration parameters associated with the target rendering operation of the 3D scene description;
generating a second fused representation of inputs comprising the encoded visual feature representations, the encoded system performance metrics, and the encoded second set of rendering configuration parameters, using the attention-based mechanism;
predicting a second render time for the target rendering operation based at least in part on the second fused representation; and
recommending the first set of rendering configuration parameters or the second set of rendering configuration parameters based at least in part on the first render time or the second render time.

9. The method of claim 1, further comprising:
encoding a second set of rendering configuration parameters associated with the target rendering operation of the 3D scene description;
generating a second fused representation of inputs comprising the encoded visual feature representations, the encoded system performance metrics, and the encoded second set of rendering configuration parameters, using the attention-based mechanism;
predicting a second render time for the target rendering operation based at least in part on the second fused representation;
presenting a selection of the first set of rendering configuration parameters in association with the first render time and the second set of rendering configuration parameters in association with the second render time; and
responsive to receiving a user selection of one of the first set of rendering configuration parameters or the second set of rendering configuration parameters, performing the target render operation according to the selected set of rendering configuration parameters.

10. The method of claim 1, the method further comprising:
obtaining a training data set comprising, for a 3D training scene description:
a plurality of sets of training render configuration parameters,
a set of fine pass rendering times, wherein a particular fine pass rendering time corresponds to a fine pass rendering of the 3D training scene description using a particular set of training render configuration parameters of the plurality of sets of training render configuration parameters, and
auxiliary rendered outputs extracted from the 3D training scene description from performing one or more coarse render passes on the 3D training scene description using a training set of hardware resources; and
training the multi-modal fusion model with the training data set according to a training process, wherein the training process comprises:
(a) encoding visual feature representations from the auxiliary rendered outputs using one or more convolutional neural networks (CNNs) with a first set of visual feature encoders;
(b) encoding system performance metrics, of the set of training hardware resources, captured during the one or more coarse render passes, with a second encoder;
(c) generating a set of encoded training render configuration parameters for the respective sets of training render configuration parameters in the plurality of sets of training render configuration parameters using a third encoder;
(d) for a particular set of training configuration parameters:
generating a fused representation of inputs comprising the encoded visual feature representations, the encoded system performance metrics, and the encoded particular set of training configuration parameters, using an attention-based mechanism that weights contributions of the respective inputs using a third set of weights;
predicting a render time based at least in part on the fused representation of inputs; and
comparing the predicted render time to the particular fine pass rendering time, of the set of fine pass rendering times, that corresponds to the particular set of training configuration parameters;
(e) responsive to determining that the predicted render time does not satisfy a learning condition with respect to the fine pass rendering time, modifying at least one of: the first encoder, the second encoder, or the third set of weights; and
(f) repeating steps (a)-(e) until the predicted render time satisfies the learning condition.

11. The method of claim 1, wherein encoding the system performance metrics of the set of hardware resources associated with the one or more coarse render passes comprises using a fully connected neural network.

12. The method of claim 1, wherein encoding the rendering configuration parameters associated with the target rendering operation of the 3D scene description comprises using a fully connected neural network.

13. The method of claim 1, wherein the attention-based mechanism comprises a multi-headed attention model.

14. One or more non-transitory computer-readable media comprising instructions that, when executed by one or more hardware processors, cause performance of operations comprising:
accessing auxiliary rendered outputs generated from performing one or more coarse render passes on a three-dimensional (3D) scene description using a set of hardware resources;
accessing system performance metrics of the set of hardware resources associated with the one or more coarse render passes;
encoding visual feature representations from the auxiliary rendered outputs using one or more convolutional neural networks (CNNs);
encoding the system performance metrics;
encoding a first set of rendering configuration parameters associated with a target rendering operation of the 3D scene description;
generating, using a multi-modal fusion model, a first fused representation of inputs comprising the encoded visual feature representations, the encoded system performance metrics, and the encoded first set of rendering configuration parameters, using an attention-based mechanism that weights contributions of the respective inputs; and
predicting a first render time for the target rendering operation based at least in part on the first fused representation.

15. The one or more non-transitory computer-readable media of claim 14, the operations further comprising:
performing the one or more coarse render passes on the 3D scene description to generate the auxiliary rendered outputs using the set of hardware resources; and
capturing the system performance metrics while performing the one or more coarse render passes.

16. The one or more non-transitory computer-readable media of claim 14, the operations further comprising: using the first render time in a scheduling operation for the target rendering operation.

17. The one or more non-transitory computer-readable media of claim 14, the operations further comprising:
encoding a second set of rendering configuration parameters associated with the target rendering operation of the 3D scene description;
generating a second fused representation of inputs comprising the encoded visual feature representations, the encoded system performance metrics, and the encoded second set of rendering configuration parameters, using the attention-based mechanism;
predicting a second render time for the target rendering operation based at least in part on the second fused representation; and
recommending the first set of rendering configuration parameters or the second set of rendering configuration parameters based at least in part on the first render time or the second render time.

18. The one or more non-transitory computer-readable media of claim 14, the operations further comprising:
encoding a second set of rendering configuration parameters associated with the target rendering operation of the 3D scene description;
generating a second fused representation of inputs comprising the encoded visual feature representations, the encoded system performance metrics, and the encoded second set of rendering configuration parameters, using the attention-based mechanism;
predicting a second render time for the target rendering operation based at least in part on the second fused representation;
presenting a selection of the first set of rendering configuration parameters in association with the first render time and the second set of rendering configuration parameters in association with the second render time; and
responsive to receiving a user selection of one of the first set of rendering configuration parameters or the second set of rendering configuration parameters, performing the target render operation according to the selected set of rendering configuration parameters.

19. The one or more non-transitory computer-readable media of claim 14, the operations further comprising:
obtaining a training data set comprising, for a 3D training scene description:
a plurality of sets of training configuration parameters,
a set of fine pass rendering times, wherein a particular fine pass rendering time corresponds to a fine pass rendering of the 3D training scene description using a particular set of training render configuration parameters of the plurality of sets of training configuration parameters, and
auxiliary rendered outputs extracted from the 3D training scene description from performing one or more coarse render passes on the 3D training scene description using a training set of hardware resources;
training the multi-modal fusion model with the training data set according to a training process, wherein the training process comprises:
(a) encoding visual feature representations from the auxiliary rendered outputs using one or more convolutional neural networks (CNNs) with a first set of visual feature encoders;
(b) encoding system performance metrics, of the set of training hardware resources, captured during the one or more coarse render passes, with a second encoder;
(c) generating a set of encoded training render configuration parameters for the respective set of training render configuration parameters in the plurality of sets of training render configuration parameters using a third encoder;
(d) for the particular set of training configuration parameters:
generating a fused representation of inputs comprising the encoded visual feature representations, the encoded system performance metrics, and the encoded particular set of training configuration parameters, using an attention-based mechanism that weights contributions of the respective inputs using a third set of weights;
predicting a render time based at least in part on the fused representation of inputs; and
comparing the predicted render time to the particular fine pass rendering time, of the set of fine pass rendering times, that corresponds to the particular set of training configuration parameters;
(e) responsive to determining that the predicted render time does not satisfy a learning condition with respect to the fine pass rendering time, modifying at least one of: the first encoder, the second encoder, or the third set of weights; and
repeating steps (a)-(e) until the predicted render time satisfies the learning condition.

20. A system comprising:
one or more hardware processors;
one or more non-transitory computer-readable media; and
program instructions stored on the one or more non-transitory computer-readable media that, when executed by the one or more hardware processors, cause the system to perform operations comprising:
accessing auxiliary rendered outputs generated from performing one or more coarse render passes on a three-dimensional (3D) scene description using a set of hardware resources;
accessing system performance metrics of the set of hardware resources associated with the one or more coarse render passes, the system performance metrics comprising at least one of: a CPU load, a GPU load, or memory consumption;
encoding visual feature representations from the auxiliary rendered outputs using one or more convolutional neural networks (CNNs), wherein the visual feature representations comprise at least one of: a single value per pixel in the 3D scene description, a three-value vector per pixel in the 3D scene description, or a four-value vector per pixel in the 3D scene description;
encoding the system performance metrics;
encoding a first set of rendering configuration parameters associated with a target rendering operation of the 3D scene description, wherein the rendering configuration parameters comprise at least one of: resolution, sample rate, bounce limit, camera parameters, lighting parameters, material parameters, texture parameters, or render settings;
generating, using a multi-modal fusion model, a first fused representation of inputs comprising the encoded visual feature representations, the encoded system performance metrics, and the encoded first set of rendering configuration parameters, using an attention-based mechanism that weights contributions of the respective inputs; and
predicting a first render time for the target rendering operation based at least in part on the first fused representation.
